(19) United States
(12) Patent Application Publication
(10) Pub. No.: US 2008/0231188 A1
(43) Pub. Date: Sep. 25, 2008

(54) PLASMA DISPLAY PANEL AND METHOD FOR MANUFACTURING THE SAME

(76) Inventors: Jong-woo Choi, Suwon-si (KR); Won-ju Yi, Suwon-si (KR); Yong-shik Hwang, Suwon-si (KR); Jae-ik Kwon, Suwon-si (KR); Tae-seung Cho, Suwon-si (KR); Kyoung-doo Kang, Suwon-si (KR); Byoung-min Chun, Suwon-si (KR); Seok-gyun Woo, Suwon-si (KR); Young-do Choi, Suwon-si (KR); Seong-gi Choo, Suwon-si (KR); Hyun-min Son, Suwon-si (KR)

Correspondence Address: CHRISTIE, PARKER & HALE, LLP, PO BOX 7068, PASADENA, CA, 91109-7068, US

(21) Appl. No.: 12/013,977

(22) Filed: Jan. 14, 2008

(30) Foreign Application Priority Data
Mar. 20, 2007 (KR) 10-2007-0027053

(51) Int. Cl. H01J 17/49; H01J 9/02

(52) U.S. Cl. 313/584; 445/24

(57) ABSTRACT

A plasma display panel includes a first electrode sheet and a second electrode sheet. Each sheet includes inside lines extending in one direction, each inside line having a discharge electrode forming a closed curve discharge unit and being separated from and electrically connected to an adjacent closed curve discharge unit by a first connection unit. The discharge electrode is of a material subject to an anodization such that anodization forms a dielectric layer having an anodization thickness to an outside of the closed curve discharge unit larger than an anodization thickness to an inside of the closed curve discharge unit, the inside of the closed curve discharge unit forming a sheet discharge hole.

### CROSS-REFERENCE TO RELATED APPLICATIONS

This application claims priority to and the benefit of Korean Patent Application No. 2007-0027053, filed on Mar. 20, 2007, in the Korean Intellectual Property Office, the entire content of which is incorporated herein by reference.

### BACKGROUND

1. Field of the Invention

The present invention relates to a plasma display panel and a method for manufacturing the same, and, more particularly, to a plasma display panel having a modified electrode structure for preventing an erroneous discharge.

2. Discussion of Related Art

The plasma display panel (PDP) is a flat panel display that displays images by allowing a phosphor to emit the light by means of plasma generated in a gas discharge, The PDP has high luminance and luminous efficiency and a wide viewing angle, as compared to a liquid crystal display (LCD) or a field emission display (FED). As such, the PDP in recent years has come into the spotlight as a substitute for a cathode ray tube (CRT) display.

The PDP can be categorized as a DC PDP or an AC PDP, depending on the structure of pixels arranged in a matrix mode and the waveform of a driving voltage. In the case of the DC PDP, all electrodes are exposed to a discharge space, and therefore electric charges are directly transferred between the corresponding electrodes. In the case of the AC PDP, at least one of the corresponding electrodes is surrounded with a dielectric, and therefore electric charges are not directly transferred between the corresponding electrodes.

Also, the structure of the PDP may be divided into an opposed discharge structure and a surface discharge structure, depending on the configuration of the electrodes for discharge. In the case of the opposed discharge structure, an address discharge for selecting pixels and a sustain discharge for sustaining a discharge are generated between a scan electrode (anode) and an address electrode (cathode). In the case of the surface discharge structure, an address discharge for selecting pixels is generated between an address electrode and a scan electrode which are crossed with each other, and a sustain discharge for sustaining a discharge is generated between the scan electrode and the sustain electrode.

FIG. 1 is a partial perspective view showing one embodiment of a conventional PDP driven in a three-electrode surface discharge system, and FIG. 2 is a cross-sectional view showing one pixel thereof.

A plurality of sustain electrodes 12a and scan electrodes 12b are formed in parallel on an upper substrate 17, the sustain electrodes 12a and the scan electrodes 12b being covered with a dielectric 15 and a protective layer 16. The sustain electrodes 12a and the scan electrodes 12b include transparent electrodes 13a, 13b and metal electrodes 14a, 14b for enhancing conductivity, the transparent electrodes 13a, 13b being formed of Indium Tin Oxide (ITO), and the like.

A plurality of address electrodes 25 covered with a dielectric 26 is formed on a lower substrate 24. A barrier rib 27 is formed in parallel with an address electrode 25 on a dielectric 26 arranged between a plurality of the address electrodes 25, and a phosphor layer 28 is formed on both sides of the barrier rib 27 and the dielectric 26.

The upper substrate 17 and the lower substrate 24 are adhered to each other so that the sustain electrode 12a can be crossed with the address electrode 25 and the scan electrode 12b can be crossed with the address electrode 25. A plurality of pixels is configured by sealing a gas for forming plasma in a closed discharge space 18 formed by barrier ribs 27.

The conventional PDP thus configured has layers on the upper substrate 17 and the lower substrate 24, respectively, to form a transparent electrode, a metal electrode, a dielectric and a protective layer. The upper substrate 17 and the lower substrate 24 are combined into an assembly.

However, such a process for manufacturing a PDP is complicated, and also requires various materials, resulting in an increase in manufacturing cost. Also, because the dielectric 15 and the protective layer 16 are formed on the upper substrate 17 of the discharge space 18, a luminous efficiency is low due to low transmissivity of the light emitted from the phosphor layer 28. Also, the address discharge voltage is high and the address voltage is slowly sustained since a discharge route between the address electrode and the sustain electrode or the scan electrode is long during the address discharge.

### SUMMARY OF THE INVENTION

In accordance with the present invention a PDP is provided for which its manufacturing process is simple and its discharge efficiency is high. The PDP includes a modified structure of the electrode which allows for adjustment of the thickness of a dielectric surrounding an electrode.

One embodiment of the present invention is achieved by providing a PDP having a first substrate and a second substrate facing and spaced apart from the first substrate. A first electrode sheet is between the first substrate and the second substrate. A second electrode sheet is between the first electrode sheet and the second substrate. The first electrode sheet includes a plurality of first inside lines extending in one direction. Each first inside line includes a first discharge electrode forming a closed curve first discharge unit and being separated from and electrically connected to an adjacent closed curve first discharge unit by a first connection unit. The first discharge electrode is of a material subject to an anodization such that anodization forms a first dielectric layer having an anodization thickness to an outside of the closed curve first discharge unit larger than an anodization thickness to an inside of the closed curve first discharge unit, the inside of the closed curve first discharge unit forming a first sheet discharge hole. First sheet frame supports support the first inside line s and form a frame of the first electrode sheet. The second electrode sheet includes a plurality of second inside lines extending in one direction, each second inside line being separated from an adjacent second inside line by second bridge supports. Each second inside line includes a second discharge electrode forming a closed curve second discharge unit and being separated from and electrically connected to an adjacent closed curve second discharge unit by a second connection unit. The second discharge electrode is of a material subject to an anodization such that anodization forms a second dielectric layer having an anodization thickness to an outside of the closed curve second discharge unit larger than an anodization thickness to an inside of the closed curve second discharge unit, the inside of the closed curve second discharge unit forming a second sheet discharge hole. Second sheet frame supports support second inside lines and form a frame of the second electrode sheet.

Another embodiment of the present invention is achieved by providing a method for manufacturing a PDP. The method includes: cutting a first metal sheet and a second metal sheet; anodizing a the first metal sheet to form a first electrode sheet having: a plurality of first inside lines extending in one direction, each first inside line comprising a first discharge electrode forming a closed curve first discharge unit and being separated from and electrically connected to an adjacent closed curve first discharge unit by a first connection unit, the first discharge electrode being of a material subject to an anodization such that anodization forms a first dielectric layer having an anodization thickness to an outside of the closed curve first discharge unit larger than an anodization thickness to an inside of the closed curve first discharge unit, the inside of the closed curve first discharge unit forming a first sheet discharge hole; anodizing the second metal sheet to form a second electrode sheet having: a plurality of second inside lines extending in one direction, each second inside line being separated from an adjacent second inside line by second bridge supports, each second inside line comprising a second discharge electrode forming a closed curve second discharge unit and being separated from and electrically connected to an adjacent closed curve second discharge unit by a second connection unit, the second discharge electrode being of a material subject to an anodization such that anodization forms a second dielectric layer having an anodization thickness to an outside of the closed curve second discharge unit larger than an anodization thickness to an inside of the closed curve second discharge unit, the inside of the closed curve second discharge unit forming a second sheet discharge hole; and coupling the first substrate, the first electrode sheet, the second electrode sheet and the second substrate to each other.

A further embodiment of the present invention is achieved by providing a PDP including a first substrate having a first discharge electrode and a first dielectric layer covering the first discharge electrode. A second substrate faces and is spaced apart from the first substrate. An electrode sheet is between the first substrate and the first dielectric layer. A protective layer is provided on a surface of the electrode sheet. The electrode sheet includes electrodes having a discharge electrode forming a closed curve discharge unit and being separated from and electrically connecting to an adjacent closed curve discharge unit by a connection unit. The discharge electrode is of a material subject to an anodization such that anodization forms a dielectric layer having an anodization thickness to an outside of the closed curve discharge unit larger than an anodization thickness to an inside of the closed curve discharge unit, the inside of the closed curve discharge unit forming a sheet discharge hole. Sheet frame supports support inside lines and form a frame of the electrode sheet.

### BRIEF DESCRIPTION OF THE DRAWINGS

FIG. 1 is a perspective view showing one embodiment of a conventional PDP.

FIG. 2 is a cross-sectional view showing one pixel in the PDP shown in FIG. 1.

FIG. 3 is an exploded perspective view showing a PDP according to a first embodiment of the present invention.

FIG. 4 is a cross-sectional view of an unexploded depiction of the first embodiment shown in FIG. 3.

FIG. 5A is a perspective view showing one embodiment of a first electrode sheet shown in FIG. 3.

FIG. 5B is an enlarged perspective view showing a circumferential region of a unit discharge hole of the first electrode sheet shown in FIG. 5A.

FIG. 5C is a cross-sectional view taken from a line B-B′ shown in FIG. 5B.

FIG. 6A is a perspective view showing one embodiment of a second electrode sheet shown in FIG. 3.

FIG. 6B is an extended view showing a circumferential region of a unit discharge hole of the second electrode sheet shown in FIG. 6A.

FIG. 6C is a cross-sectional view taken from a line C-C′ shown in FIG. 6B.

FIG. 7 is a cut-away perspective view showing an electrode sheet.

FIGS. 8A, 8B, 8C and 8D are cross-sectional views illustrating a method for manufacturing a PDP according to the first embodiment of the present invention.

FIG. 9 is a partially exploded perspective view showing a PDP according to a second embodiment of the present invention.

FIG. 10 is a cross-sectional view of an unexploded depiction of the second embodiment shown in FIG. 9.

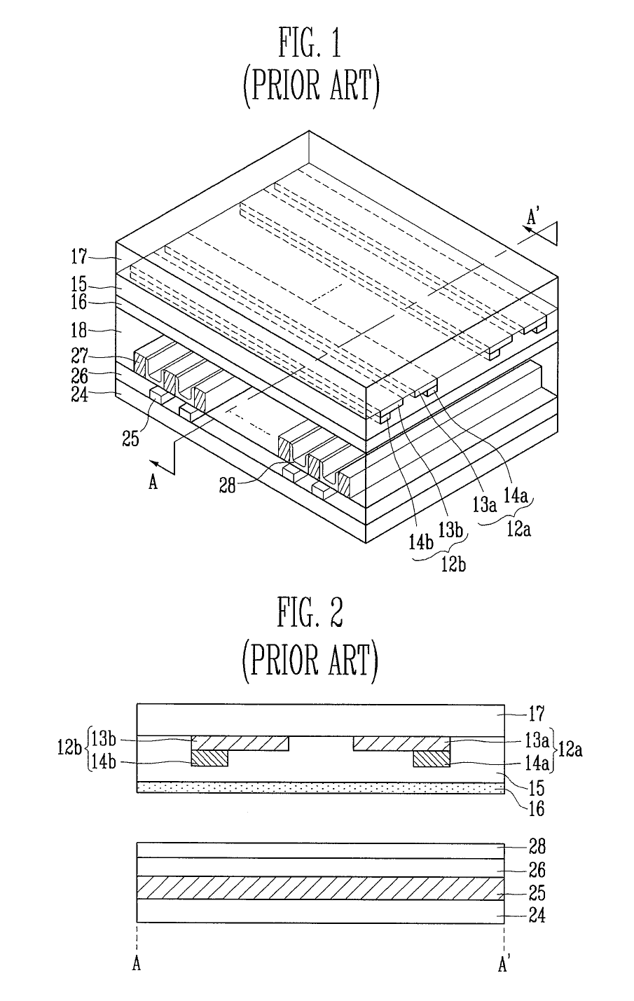

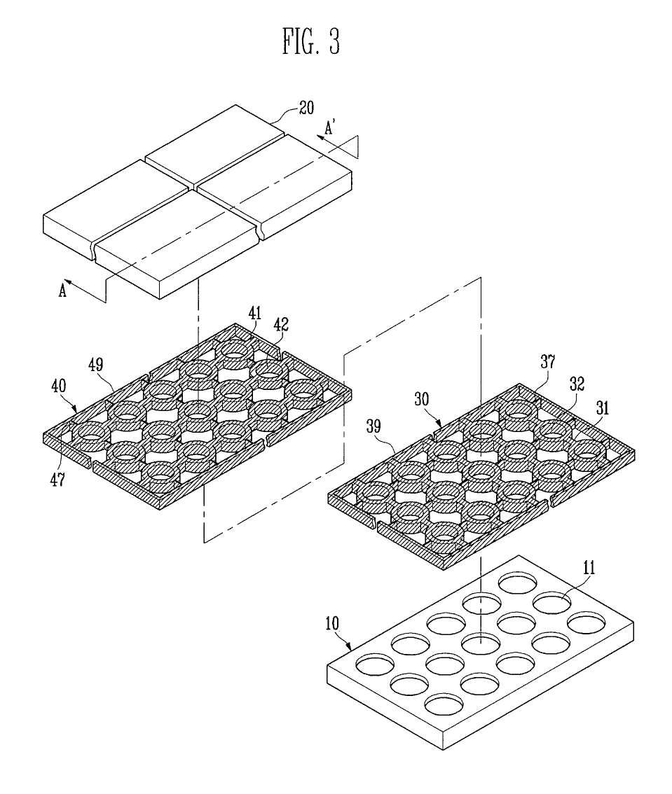

### DETAILED DESCRIPTION OF EXEMPLARY EMBODIMENTS

Referring to FIG. 3 and FIG. 4, the PDP includes a rear glass substrate 10, a front glass substrate 20, a first electrode sheet 30 and a second electrode sheet 40. The rear glass substrate 10 and the front glass substrate 20 are arranged spaced apart at a constant distance, with the first electrode sheet 30 and the second electrode sheet 40 provided between them.

The first electrode sheet 30 includes first inside lines 31, each first inside line 31 including a first dielectric layer 33 and a first discharge electrode 35; a first bridge support 37 for supporting the first inside lines 31; and a first sheet frame support 39 for connection to both the first inside lines 31 and to the first bridge supports 37. A plurality of first sheet discharge holes 32 are formed in the first inside lines 31.

The second electrode sheet 40 includes second inside lines 41, each second inside line 41 including a second dielectric layer 43 and a second discharge electrode 45; a second bridge support 47 for supporting the second inside lines 41; and a second sheet frame support 49 for connection to both the second inside lines 41 and to the second bridge support 47. A plurality of second sheet discharge holes 42 are formed in the second inside lines 41.

The first dielectric layer 33 and the second dielectric layer 43 may be formed by anodization so that the outer diameters of the respective electrodes around each of the discharge holes are larger than the outer diameters of the discharge holes.

The term “anodization” is a process in which a thin oxide film is formed on a surface of a metal to protect the inside of the metal. The oxide film is applied to a metal that can form an oxide film on its surface by itself since it is mainly a metal having a high reactivity to oxygen, such as aluminum (Al), titanium (Ti), and magnesium (Mg), and the metal anodizing method artificially forms an oxide film having a constant thickness by accelerating an oxidation reaction in the metal surface so that the metal can serve as an anode in a certain solution (sulfuric acid, etc.).

If the metal having a predetermined thickness is exposed to an anodizing solution with a predetermined time and density, the exposed region is oxidized to lose metal properties, and therefore a surface of the metal becomes a dielectric material that loses an electrical conductivity, while the inside of the metal remains not oxidized.

In order to anodize the first inside lines and the second inside lines so that their outside has a wider width than their inside, a protective film such as Dry Film Resistor (DFR) may be attached to and detached from the walls of the first sheet discharge holes and the second sheet discharge holes, and then an anodized width of a region where a protective film is not attached may be formed.

In this embodiment, the discharge space has the rear glass substrate 10 formed as a bottom surface, the front glass substrate 20 formed as a top surface, each of the first sheet discharge holes 32 and the second sheet discharge holes 42 formed as an inner wall surface, and includes a discharge gas formed therein.

A first groove 11 and a second groove 21 are formed on surfaces of the rear glass substrate 10 and the front glass substrate 20 in which the discharge space is formed, the first groove 11 and the second groove 21 being etched at a predetermined depth, and phosphor layers 13, 23 are provided in the first groove 11 and the second groove 21. Alternatively, a groove for forming a phosphor layer may be provided in only one side of the front glass substrate 20 or the rear glass substrate 10.

The PDP is then driven from an external power source and discharges are produced by first discharge electrodes 35 of the first electrode sheet 30 interacting with the second discharge electrode 45 of the second electrode sheet 40.

For example, if the power source is applied to the first discharge electrodes 35 and to the second discharge electrodes 45, the PDP is driven using the first discharge electrode 35 as scan and Y electrodes, and the second discharge electrode 45 serves as address and X electrodes in order to drive the PDP.

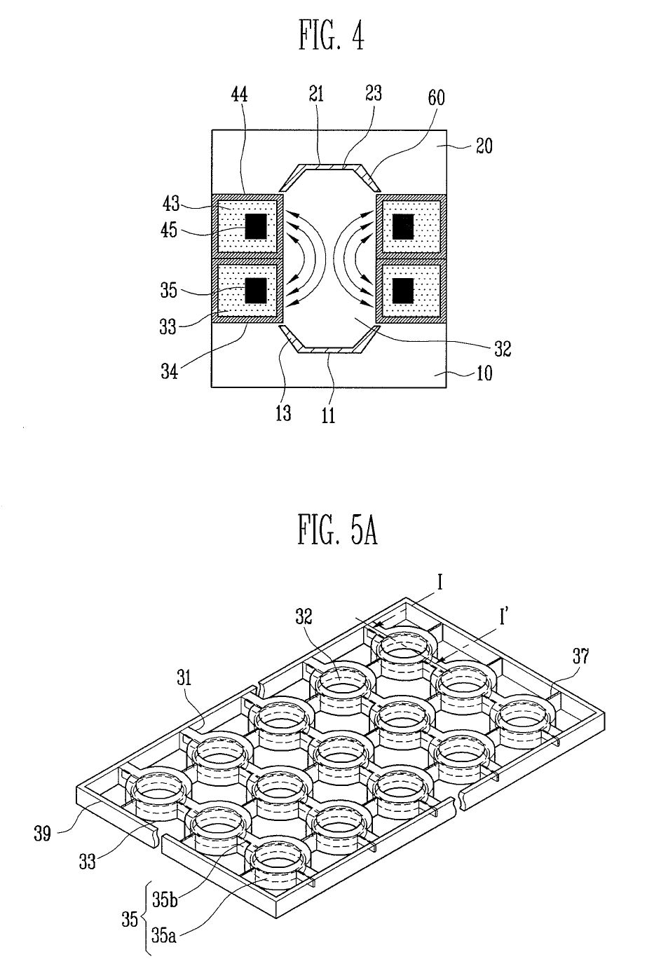

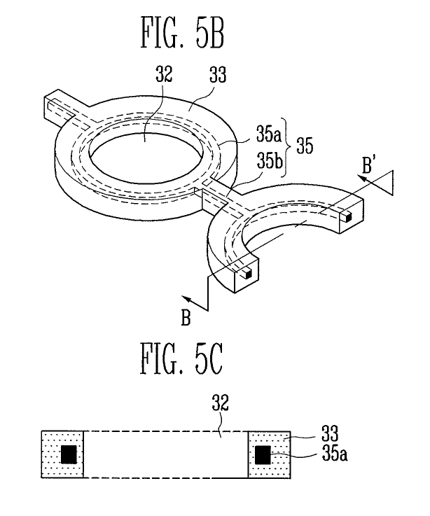

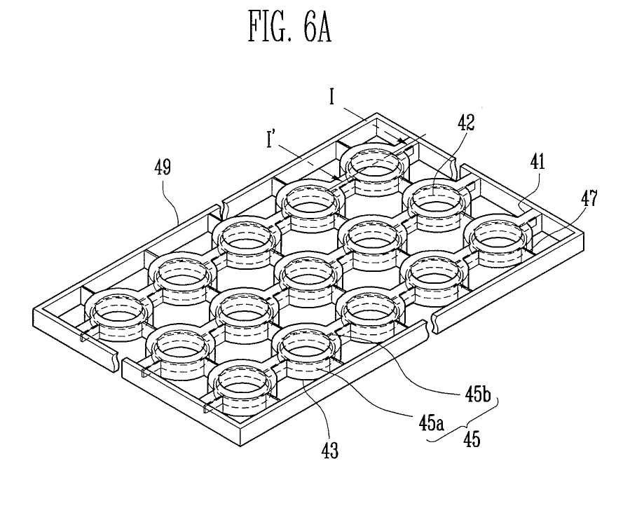

A configuration of the first electrode sheet used in accordance with the present invention will be described in more detail with reference to FIGS. 5A, 5B and 5C. FIG. 5A is a perspective view showing one embodiment of a first electrode sheet shown in FIG. 3. FIG. 5B is an extended view showing a circumferential region of a unit sheet discharge hole in the first electrode sheet shown in FIG. 5A. FIG. 5C is a cross-sectional view taken from a line B-B′ shown in FIG. 5B.

The first electrode sheet 30 includes a plurality of first inside lines 31 including an anodized first dielectric layer 33 and a first discharge electrode 35 buried in the first dielectric layer 33; a first bridge support 37 for supporting the first inside lines 31; and a first sheet frame support 39.

The first inside line 31 includes a first discharge electrode 35 and a first dielectric layer 33. The first discharge electrode 35 is an electrode for supplying a power source to discharge cells, and it is buried inside the first dielectric layer 33 and not exposed to its surface. The first discharge electrode 35 is composed of a first discharge unit 35a and a first connection unit 35b.

The first discharge unit surrounds the outside of the above-mentioned first sheet discharge hole 32 within the first dielectric layer 33. The first connection unit 35b connects the first discharge units 35a, receives power from a power source from the outside. The first discharge electrode 35 is composed of the same metal as the metal (M) of the metal oxide (MxOy) which is the material of the first dielectric layer 33 formed using an anodization process.

The first dielectric layer 33 is a layer for burying the first discharge electrode 35, and has a plurality of the above-mentioned first sheet discharge holes 32. The first dielectric layer 32 is composed of a metal oxide (MxOy) obtained by anodizing a metal M which is a material of the first discharge electrode 35.

The first dielectric layer 33 is formed at a thickness such that a width from a surface of the first discharge electrode 35 to the outside of the first dielectric layer 33 is wider than a width from a surface of the first discharge electrode 35 to the outside of the first sheet discharge hole 32, the first dielectric layer 33 having substantially the same shape as the first discharge electrode 35. That is to say, the first dielectric layer 33 may be formed of a plurality of dielectric layer lines having a shape corresponding to the first discharge unit 35a and the first connection unit 35b of the first discharge electrode 35, shown in FIGS. 5A, 5B and 5C. Accordingly, an erroneous discharge caused outside the first sheet discharge hole 32 may be prevented by inducing a discharge only on the outside of the first sheet discharge hole 32 formed at a thinner thickness than on the outside of the first dielectric layer 33.

The first bridge support 37 is a connection unit for providing a supporting force for the electrodes, and is formed at a smaller width than that of the first inside line 31. The first bridge support 37 is structurally coupled with the first dielectric layer 33 of the first inside line 31 rather than being structurally coupled with the first discharge electrode 35 when the first electrode sheet 30 is formed through an anodization process, as described below, allowing the first bridge support 37 to be formed at a smaller width than that of the first inside line 31.

Also, the first sheet frame support 39 connects the first bridge supports 37, and helps the first electrode sheet 30 have a predetermined shape.

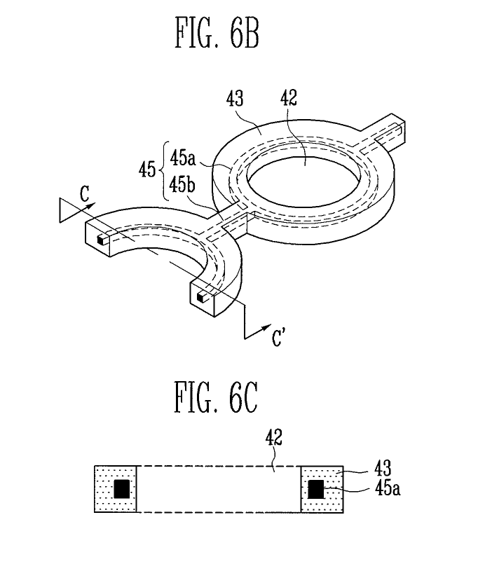

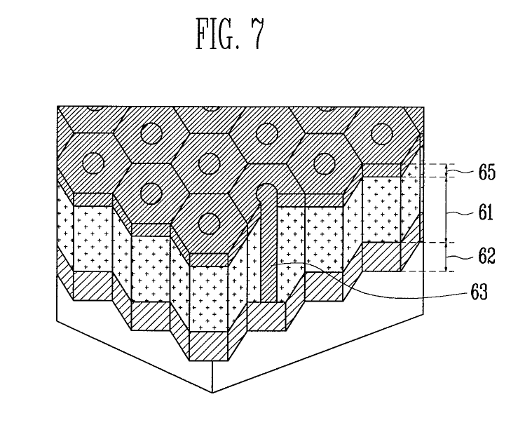

Next, a configuration of the second electrode sheet used in the present invention will be described in more detail with reference to FIG. 6A to FIG. 6C. FIG. 6A is a perspective view showing one embodiment of a second electrode sheet shown in FIG. 3. FIG. 6B is an expanded view showing a circumferential region of a unit sheet discharge hole in the second electrode sheet shown in FIG. 6A. FIG. 6C is a cross-sectional view taken from a line C-C′ shown in FIG. 6B.

Referring to FIGS. 6A, 6B and 6C, the second electrode sheet 40 includes a plurality of second inside lines 41 including an anodized second dielectric layer 43 and a second discharge electrode 45 buried inside the second dielectric layer 43; a second bridge support 47 for supporting the second discharge electrodes; and a second sheet frame support 49.

The second inside line 41 includes a second discharge electrode 45 and a second dielectric layer 43. The second discharge electrode 45 is an electrode for supplying a power source to discharge cells, and it is buried inside the second dielectric layer 43 and is not exposed to its surface. The second discharge electrode 45 is composed of a second discharge unit 45a and a second connection unit 45b.

The second discharge unit surrounds the outside of the second sheet discharge hole 42 from inside the second dielectric layer 43. The second connection unit 45b connects the second discharge units 45A, and it receives power from a power source from the outside. The second discharge electrodes 45 are composed of the same metal as the metal (M) of the metal oxide (MxOy) which is a material of the second dielectric layer 43 formed using an anodization process.

Also, the second dielectric layer 43 is a layer for burying the second discharge electrode 45, and has a plurality of the above-mentioned second sheet discharge holes 42. The second dielectric layer 43 is composed of a metal oxide (MxOy) obtained by anodizing a metal M which is a material of the second discharge electrode 45.

The second dielectric layer 43 is formed at a thickness such that a width from a surface of the second discharge electrode 45 to the outside of the second dielectric layer 43 is wider than a width from a surface of the second discharge electrode 45 to the outside of the second sheet discharge hole 42, and therefore the second dielectric layer 43 may have substantially the same shape as the second discharge electrode 45. That is to say, the second dielectric layer 43 may be formed of a plurality of dielectric layer lines having a shape corresponding to the second discharge unit 45a and the second connection unit 45b of the second discharge electrode 45, shown in FIG. 5A to FIG. 5C. Accordingly, an erroneous discharge caused outside the second sheet discharge hole 42 may be prevented by inducing a discharge only on the outside of the second sheet discharge hole 42 formed at a thinner thickness than on the outside of the second dielectric layer 43.

The second bridge support 47 is a connection unit for providing a supporting force for the electrodes, and is formed at a smaller width than that of the second inside line 41. The second bridge support 47 is structurally coupled with the second dielectric layer 43 of the second inside line 41 rather than being structurally coupled with the second discharge electrode 45 when the first electrode sheet 30 is formed through an anodization process, as described below, allowing the second bridge support 47 to be formed at a smaller width than that of the second inside line 41.

The second sheet frame support 49 connects the second bridge supports 47, and helps the second electrode sheet 40 have a predetermined shape.

The second discharge electrode 45 and the first discharge electrode 35 are provided so that they can be crossed with each other, and they are electrodes for reacting with each other to cause a discharge, and both electrodes play a complementary role to each other. That is to say, if the first discharge electrode 35 serves as a scan electrode during an address period and serves as a Y electrode during a sustain period in driving an electrode sheet. Then, the second discharge electrode 45 serves as a first discharge electrode during an address period and serves as an X electrode during a sustain period.

Referring to FIG. 3 and FIG. 4 again, a discharge space is formed respectively inside the discharge holes 32, 42 of the electrode sheets, and a non-discharge space is formed outside the discharge holes 32, 42, that is, between electrode and electrode and between electrode and frame support. The first dielectric layer and the second dielectric layer are formed so that the width from the respective first and second electrodes to the outside of the first dielectric layer and the second dielectric layer is wider than a with from the respective first and second electrodes to the outside of the first sheet discharge hole and the second sheet discharge hole, the first dielectric layer and second dielectric layer being formed by burying the first discharge electrode 35 and the second discharge electrode so as to prevent a discharge in the non-discharge space. This is done to solve the problem that its luminous efficiency is deteriorated due to the discharge, namely the erroneous discharge in the non-discharge space.

As seen in FIG. 4, a first protective layer 34 and a second protective layer 44 are provided on surfaces of the first dielectric layer 33 and the second dielectric layer 43, the first and second protective layers 34,44 serving to protect electrodes during a discharge and lower a discharge voltage by means of secondary electron emission.

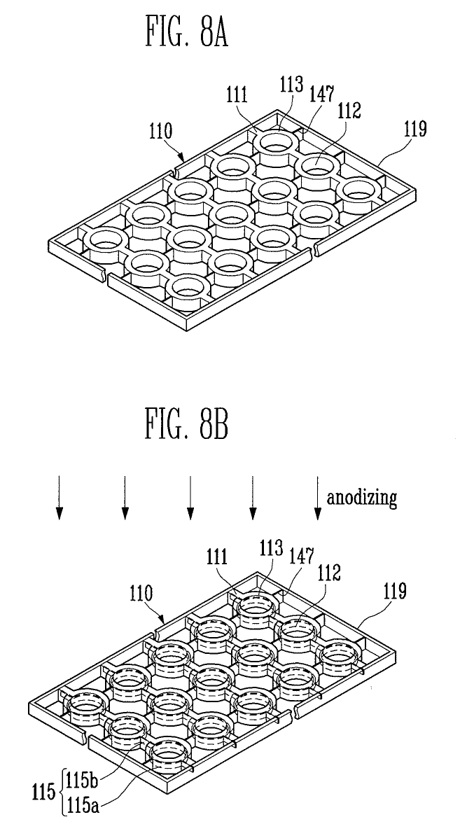

Referring now to FIG. 7, a cut-away perspective view shows a surface of an electrode sheet having a protective layer. The dielectric layer formed through the anodization as in the first embodiment of the present invention generally includes fine pores 63 having a diameter of several tens nanometers. That is to say, if a metal sheet is subject to the anodization, the surface of the anodized dielectric layer is divided into a fine pore layer 61 having fine pores formed therein and a fine pore-free barrier layer 62.

In a region where the fine pore 63 is formed protective layer 65 is uniformly formed in the surface of the dielectric layer. That is to say, the protective layer 65 is also uniformly filled inside the fine pore 63. This is why the protective layers 34, 35 have a secondary electron emission characteristic and harmoniously serve to protect discharge cells, enhance voltage resistance, etc. The protective layer 65 is formed of the same material as in the dielectric layer, or formed of magnesium oxide (MgO).

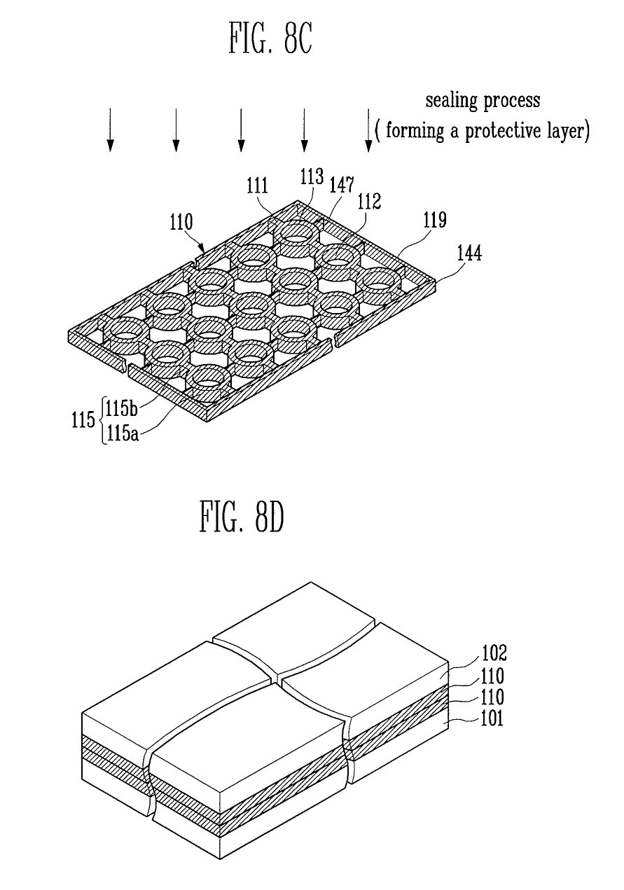

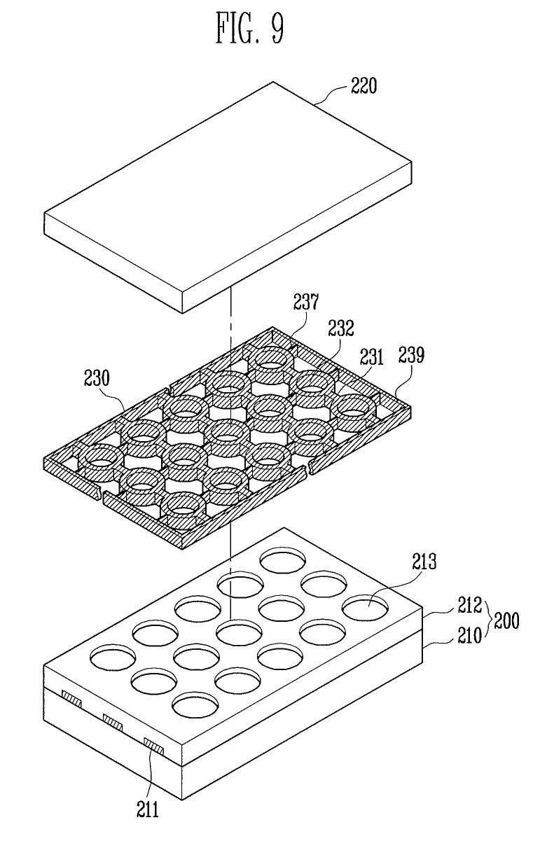

The method for manufacturing a PDP according to the first embodiment of the present invention will now be described with reference to FIGS. 8A, 8B, 8C and 8D.

First, the metal sheets 110 are cut into pieces including an electrode 111, a frame support 119 and a bridge support 147. A discharge hole 112 is formed on the electrode 111. In order to ensure a supporting force, the bridge support 147 connects the electrodes 111 to frame support 119 which has a smaller width than the electrodes. (see FIG. 8A)

Then, the metal sheet 110 is anodized and extended in one direction to form an electrode sheet 111. A frame support 119 forms a frame of the electrode sheet. The electrodes 111 include a plurality of discharge units forming a closed curve. A discharge electrode 115 includes a connection unit for electrically connecting the discharge units. A dielectric layer 113 has a discharge hole passed through the closed curve of the discharge unit and buries the discharge electrode 115, a material of which is anodized so that a width to the outside of the dielectric layer 113 can be wider than a width to the outside of the discharge hole 112. In an exemplary embodiment the closed curve is circular. In order to anodize the discharge electrode 115 so that a width to the outside of the dielectric layer 113 is wider than a width to the outside of the discharge hole 112, a protective film such as Dry Film Resistor (DFR) is attached and detached at the outside of the discharge hole.

The anodizing is generally an electrochemical oxidation of a metal surface for forming stable oxide on the metal surface. (see FIG. 8B)

Subsequently, the protective layer 120 is formed using an electronic sealing process in which materials of the protective layer may be filled in fine pores of the electrode sheet 111 and also be uniformly formed over the entire surface. The protective layer 120 is formed of the same materials as in the dielectric layer, or formed of magnesium oxide (MgO). The electronic sealing process is a method for electrochemically introducing inorganic materials into fine pores, depositing the inorganic materials and sealing the fine pores, wherein metal salts are AC-electrolyzed in an electrolytic bath. (see FIG. 8C)

Finally, a PDP is prepared by matching a position of grooves with a position of the discharge holes 112 of the electrode sheets 110 and coupling the positions with each other to form a discharge space between them, the grooves being coated with a phosphor layer and formed in the first substrate 101 and the second substrate 102. (see FIG. 8D)

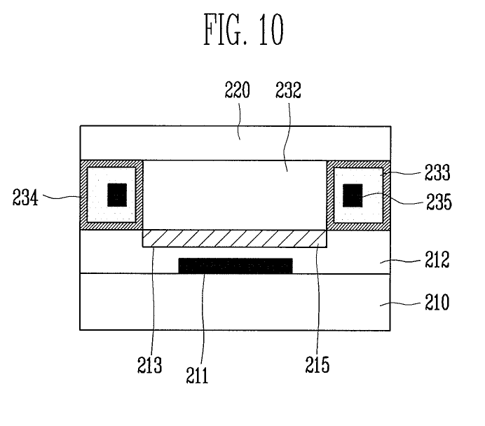

FIG. 9 is a partially exploded perspective view showing a PDP according to a second embodiment of the present invention, and FIG. 10 is a cross-sectional view of an unexploded depiction of the second embodiment shown in FIG. 9. In the second embodiment, the same parts as in the first embodiment are omitted and parts different from those of the first embodiment will be described.

The PDP includes a rear panel 200, a front glass substrate 220 and an electrode sheet 230.

The rear panel 200 and the front glass substrate 220 are arranged spaced apart at a constant distance, and an electrode sheet is provided between them. The rear panel 200 includes a first discharge electrode 211 and a first dielectric layer 212 on the rear glass substrate 210. The first discharge electrode 211 is formed on the rear panel 200 facing the front glass substrate 220 in such a direction that the first discharge electrode 211 is crossed with the electrode 231 of the electrode sheet 230. The first discharge electrodes 211 are covered and buried within the first dielectric layer 212, and a groove 213 having a predetermined depth is formed on the first dielectric layer 212, the groove 213 having a phosphor layer 215 formed therein. The groove 213 forms a bottom surface of the discharge cells.

The electrode sheet 230 includes an electrode 231 including a second dielectric layer 233 and a second discharge electrode 235; a bridge support 237 for supporting the electrodes 231; and a frame support 237 for connection to both bridge support 237 and to electrode 231. A plurality of discharge holes 232 are formed on the electrode 231. The second dielectric layer 233 is formed by means of the anodization so that the thickness to the outside of the second discharge layer 233 is larger than the thickness to the outside of the discharge hole 232. A further description of an electrode sheet 230 is omitted since the electrode sheet 230 is similar to that of the first embodiment.

A discharge space is formed inside the discharge hole 232 of the electrode sheet 230, and a non-discharge space is formed outside the discharge hole 232, that is, formed between electrode and electrode and between electrode and frame support. The second dielectric layer 233 is formed so that the thickness to the outside of the second dielectric layer 233 is larger than the thickness to the outside of the discharge hole 232, the second dielectric layer being formed by burying the second discharge electrode 235 so as to prevent a discharge in the non-discharge space. This is done to solve the problem that its luminous efficiency is deteriorated due to the discharge, namely the erroneous discharge in the non-discharge space.

A protective layer 234 is provided in a surface of the second dielectric layer 233 in the electrode sheet, the protective layer 234 serving to protect electrodes during a discharge and lower a discharge voltage by means of secondary electron emission.

The protective layer 234 of this embodiment is provided in a region where the fine pores formed on the surface of the second dielectric layer 233 are distributed, and therefore the protective layer 234 is uniformly formed on the surface of the second dielectric layer 233. That is to say, the protective layer 234 is uniformly formed also by filling the fine pores with the protective layer 234. The protective layer 234 is formed of the same materials as in the dielectric layer, or formed of magnesium oxide (MgO).

In this embodiment, the discharge space has the rear glass substrate 210 formed as a bottom surface and the front glass substrate 220 formed as a top surface. The discharge hole formed in the electrode sheet has an outer wall surface and includes a discharge gas formed therein.

In this case, the PDP is driven from an external power source and a discharge between a first discharge electrode 211 provided inside the rear panel 200 and a second discharge electrode 235 provided in the electrode sheet 230 is generated.

For example, If the power source is applied to the first discharge electrode 211 and to the second discharge electrode 235, the first discharge electrode 211 serves as scan and Y electrodes, and the second discharge electrode 235 serves as address and X electrode in order to drive the PDP.

Those skilled in the art will appreciate that the manufacturing of the second embodiment is easily performed based upon a manufacturing method for the first embodiment.

As described above, the PDP according to the present invention may be useful to simplify a manufacturing process with the improvement in the configuration of the electrodes and, as a result, improve the discharge efficiency by vertically arranging the electrodes causing the sustain discharge by themselves to widen an effective discharge area where a sustain discharge is caused. Also, the PDP according to the present invention may also be useful to control a firing voltage by setting a firing voltage in a non-discharge region at a higher level than that in a discharge region by adjusting a thickness of the dielectric surrounding the electrodes, and ensuring a stable discharge by preventing an erroneous discharge in a region other than the effective region.

Although exemplary embodiments of the present invention have been shown and described, it would be appreciated by those skilled in the art that changes might be made in these embodiments without departing from the principles and spirit of the invention, the scope of which is defined in the claims and their equivalents. For example, the first discharge electrode may also be manufactured in the form of an electrode sheet having straight-line electrodes.

What is claimed is:

1. A plasma display panel, comprising:
a first substrate;
a second substrate facing and spaced apart from the first substrate;
a first electrode sheet between the first substrate and the second substrate; and
a second electrode sheet between the first electrode sheet and the second substrate,
wherein the first electrode sheet includes:
a plurality of first inside lines extending in one direction, each first inside line comprising a first discharge electrode forming a closed curve first discharge unit and being separated from and electrically connected to an adjacent closed curve first discharge unit by a first connection unit, the first discharge electrode being of a material subject to an anodization such that anodization forms a first dielectric layer having an anodization thickness to an outside of the closed curve first discharge unit larger than an anodization thickness to an inside of the closed curve first discharge unit, the inside of the closed curve first discharge unit forming a first sheet discharge hole; and
first sheet frame supports for supporting first inside lines and to form a frame of the first electrode sheet, and
wherein the second electrode sheet includes:
a plurality of second inside lines extending in one direction, each second inside line being separated from an adjacent second inside line by second bridge supports, each second inside line comprising a second discharge electrode forming a closed curve second discharge unit and being separated from and electrically connected to an adjacent closed curve second discharge unit by a second connection unit, the second discharge electrode being of a material subject to an anodization such that anodization forms a second dielectric layer having an anodization thickness to an outside of the closed curve second discharge unit larger than an anodization thickness to an inside of the closed curve second discharge unit, the inside of the closed curve second discharge unit forming a second sheet discharge hole; and
second sheet frame supports for supporting second inside lines and to form a frame of the second electrode sheet.

2. The plasma display panel according to claim 1, further comprising a first protective layer and a second protective layer on surfaces of the first electrode sheet and the second electrode sheet, respectively.

3. The plasma display panel according to claim 2, wherein the first protective layer and the second protective layer seal fine pores of a porous surface of the first dielectric layer and the second dielectric layer formed by anodization.

4. The plasma display panel according to claim 2, wherein the first protective layer and the second protective layer are a dielectric.

5. The plasma display panel according to claim 2, wherein the first protective layer and the second protective layer are magnesium oxide.

6. The plasma display panel according to claim 1, wherein:
each first inside line is separated from an adjacent first inside line by first bridge supports; and
each second inside line is separated from an adjacent second inside line by second bridge supports.

7. The plasma display panel according to claim 6, wherein the bridge support has a width smaller than a width of the electrode.

8. The plasma display panel according to claim 1, wherein a groove having a phosphor layer in the groove is provided in at least one of surfaces of the first substrate and the second substrate with which the first sheet discharge hole and the second sheet discharge hole is in contact.

9. A method for manufacturing a plasma display panel, the method comprising:
cutting a first metal sheet and a second metal sheet;
anodizing a the first metal sheet to form a first electrode sheet having:
a plurality of first inside lines extending in one direction, each first inside line comprising a first discharge electrode forming a closed curve first discharge unit and being separated from and electrically connected to an adjacent closed curve first discharge unit by a first connection unit, the first discharge electrode being of a material subject to an anodization such that anodization forms a first dielectric layer having an anodization thickness to an outside of the closed curve first discharge unit larger than an anodization thickness to an inside of the closed curve first discharge unit, the inside of the closed curve first discharge unit forming a first sheet discharge hole;
anodizing the second metal sheet to form a second electrode sheet having:
a plurality of second inside lines extending in one direction, each second inside line being separated from an adjacent second inside line by second bridge supports, each second inside line comprising a second discharge electrode forming a closed curve second discharge unit and being separated from and electrically connected to an adjacent closed curve second discharge unit by a second connection unit, the second discharge electrode being of a material subject to an anodization such that anodization forms a second dielectric layer having an anodization thickness to an outside of the closed curve second discharge unit larger than an anodization thickness to an inside of the closed curve second discharge unit, the inside of the closed curve second discharge unit forming a second sheet discharge hole; and
coupling the first substrate, the first electrode sheet, the second electrode sheet and the second substrate to each other.

10. The method for manufacturing a plasma display panel according to claim 9, wherein, when forming a first electrode sheet and a second electrode sheet, a protective film is attached to and detached from an internal surface of the closed curve first discharge unit and an internal surface of the closed curve second discharge unit such that when the first sheet and the second sheet are anodized the resulting first dielectric layer and second dielectric layer have an anodization thickness on an outside of the first closed curve discharge unit and the second closed curve discharge unit is larger than an anodization thickness on an inside of the first closed curve discharge unit and the second closed curve discharge unit.

11. The method for manufacturing a plasma display panel according to claim 9, further comprising a step of forming a first protective layer and a second protective layer on surfaces of the first electrode sheet and the second electrode sheet, respectively.

12. The method for manufacturing a plasma display panel according to claim 11, wherein the first protective layer and the second protective layer are formed respectively on surfaces of the first electrode sheet and the second electrode sheet using an electronic sealing process.

13. A plasma display panel, comprising:
a first substrate including a first discharge electrode and a first dielectric layer covering the first discharge electrode;
a second substrate facing and spaced apart from the first substrate;
an electrode sheet between the first substrate and the first dielectric layer; and
a protective layer on a surface of the electrode sheet,
wherein the electrode sheet includes:
a plurality of electrodes, each electrode comprising a discharge electrode forming a closed curve discharge unit and being separated from and electrically connected to an adjacent closed curve discharge unit by a connection unit, the discharge electrode being of a material subject to an anodization such that anodization forms a dielectric layer having an anodization thickness to an outside of the closed curve discharge unit larger than an anodization thickness to an inside of the closed curve discharge unit, the inside of the closed curve discharge unit forming a sheet discharge hole; and
sheet frame supports for supporting inside lines and to form a frame of the electrode sheet,

14. The plasma display panel according to claim 13, wherein the protective layer seals fine pores of a porous surface of the second dielectric layer formed with the anodization.

15. The plasma display panel according to claim 13, wherein the protective layer is filled in the fine pores of the surface of the dielectric layer formed with the anodization.

16. The plasma display panel according to claim 15, wherein the protective layer is a dielectric.

17. The plasma display panel according to claim 13, wherein the protective layer is magnesium oxide (MgO).

18. The plasma display panel according to claim 13, wherein the electrode sheet further includes bridge supports for structurally connecting adjacent electrodes to each other.

19. The plasma display panel according to claim 18, wherein the bridge supports have a width smaller width than a width of the electrode.

20. The plasma display panel according to claim 13, wherein a groove having a phosphor layer in the groove is provided in the first substrate with which the discharge hole is in contact.
